(19) United States
(12) Patent Application Publication
(10) Pub. No.: US 2011/0281447 A1
(43) Pub. Date: Nov. 17, 2011

(54) LOCKING DEVICE FOR POWER FEEDING PLUG

(75) Inventors: Hiroaki Kano, Aichi (JP); Shinji Ichikawa, Toyota-shi (JP)

(73) Assignees: TOYOTA JIDOSHA KABUSHIKI KAISHA, Aichi-ken (JP); KABUSHIKI KAISHA TOKAI RIKA DENKI SEISAKUSHO, Aichi (JP)

(21) Appl. No.: 13/101,845

(22) Filed: May 5, 2011

(30) Foreign Application Priority Data
May 12, 2010 (JP) 2010-110663

(51) Int. Cl. H01R 13/44; E05B 73/00

(52) U.S. Cl. 439/133; 70/58

(57) ABSTRACT

A power feeding plug for use with a power receiving connector includes a hook that engages the power receiving connector. A manual operation portion is operated to disengage the hook from the power receiving connector. A locking device selectively prohibits operation of the manual operation portion. The locking device includes a key cylinder operated by an authentic mechanical key. A lock mechanism moves in cooperation with the key cylinder. When the authentic mechanical key operates the key cylinder, the lock mechanism is moved between a lock position, to prohibit removal of the power feeding plug from the power receiving connector, and an unlock position, to permit removal of the power feeding plug from the power receiving connector.

### CROSS-REFERENCE TO RELATED APPLICATIONS

This application is based upon and claims the benefit of priority from prior Japanese Patent Application No. 2010-110663, filed on May 12, 2010, the entire contents of which are incorporated herein by reference.

### BACKGROUND OF THE INVENTION

The present invention relates to a locking device that locks a power feeding plug to a power receiving connector to prevent unauthorized removal of the power feeding plug from the power receiving connector.

Automobile manufacturers are developing motor-driven electric vehicles (including hybrid vehicles). In such an electric vehicle, whenever the state of charge of a vehicle battery becomes low, the battery must be charged in a household or a charging station. A charging system for an electric vehicle that is easy for a user to use has been proposed (for example, Japanese Laid-Open Patent Publication No. 9-161898). In this prior art charging system, when the user is at home, the user connects a power feeding plug, which leads to a household outlet of a commercial power supply, to an inlet of the vehicle to charge the vehicle battery with commercial power.

Although fast charging technology is being developed, the time required to charge the battery of an electric vehicle is still much longer than that required to refuel a gasoline engine vehicle. For example, when a user charges the battery of an electric vehicle at home with or without using a quick charger, the user plugs the power feeding plug to the household outlet. Then, the user connects the power feeding plug to the vehicle inlet to start charging the battery of the electric vehicle. The electric vehicle is left in this state over a long period of time. Thus, when the vehicle battery is being charged, for example, someone may remove the power feeding plug from the electric vehicle and connect the power feeding plug to another electric vehicle to steal electricity. Further, the power feeding plug may be stolen.

### SUMMARY OF THE INVENTION

The present invention provides a locking device for a power feeding device that prevents unauthorized removal of the power feeding plug from the power receiving connector.

One aspect of the present invention is a locking device for a power feeding plug. The power feeding plug includes a hook, which engages a power receiving connector, and a manual operation portion, which is operated to disengage the hook from the power receiving connector. The locking device includes a key cylinder arranged in the power feeding plug, and a lock mechanism moved in cooperation with the key cylinder. When an authentic mechanical key operates the key cylinder, the lock mechanism is moved between a lock position, to prohibit removal of the power feeding plug from the power receiving connector, and an unlock position, to permit removal of the power feeding plug from the power receiving connector.

Another aspect of the present invention is a power feeding plug for use with a power receiving connector. The power feeding plug includes a hook that engages the power receiving connector, a manual operation portion operated to disengage the hook from the power receiving connector, and a locking device that selectively prohibits operation of the manual operation portion. The locking device includes a key cylinder operated by an authentic mechanical key, and a lock mechanism that moves in cooperation with the key cylinder. When the authentic mechanical key operates the key cylinder, the lock mechanism is moved between a lock position, to prohibit removal of the power feeding plug from the power receiving connector, and an unlock position, to permit removal of the power feeding plug from the power receiving connector.

Other aspects and advantages of the present invention will become apparent from the following description, taken in conjunction with the accompanying drawings, illustrating by way of example the principles of the invention.

### BRIEF DESCRIPTION OF THE DRAWINGS

The invention, together with objects and advantages thereof, may best be understood by reference to the following description of the presently preferred embodiments together with the accompanying drawings in which:

FIG. 1 is a block diagram of a vehicle and a charging system;

FIG. 2 is a partial cross-sectional view showing a power feeding plug;

FIG. 3 is a partial cross-sectional view showing an inlet;

FIG. 4 is a perspective view showing a key cylinder;

FIG. 5 is an exploded perspective view showing the key cylinder;

FIG. 6 is a cross-sectional view of a locking device for the power feeding plug in a state in which a manual operation portion is in contact with a projection;

FIG. 7 is a cross-sectional view of the locking device with an authentic key inserted therein;

FIG. 8 is a bottom view showing the locking device;

FIG. 9(a) is a plan view showing the locking device at a lock position;

FIG. 9(b) is a plan view showing the locking device at an unlock position;

FIG. 10 is a partial cross-sectional view of the power feeding plug when being inserted into the inlet;

FIG. 11 is a partial cross-sectional view of the power feeding plug when completely inserted into the inlet;

FIG. 12 is a partial cross-sectional view of the power feeding plug when operation of the manual operation portion is prohibited; and

FIG. 13 is a partial cross-sectional view showing the power feeding plug when operation of the manual operation portion is permitted.

### DETAILED DESCRIPTION OF THE INVENTION

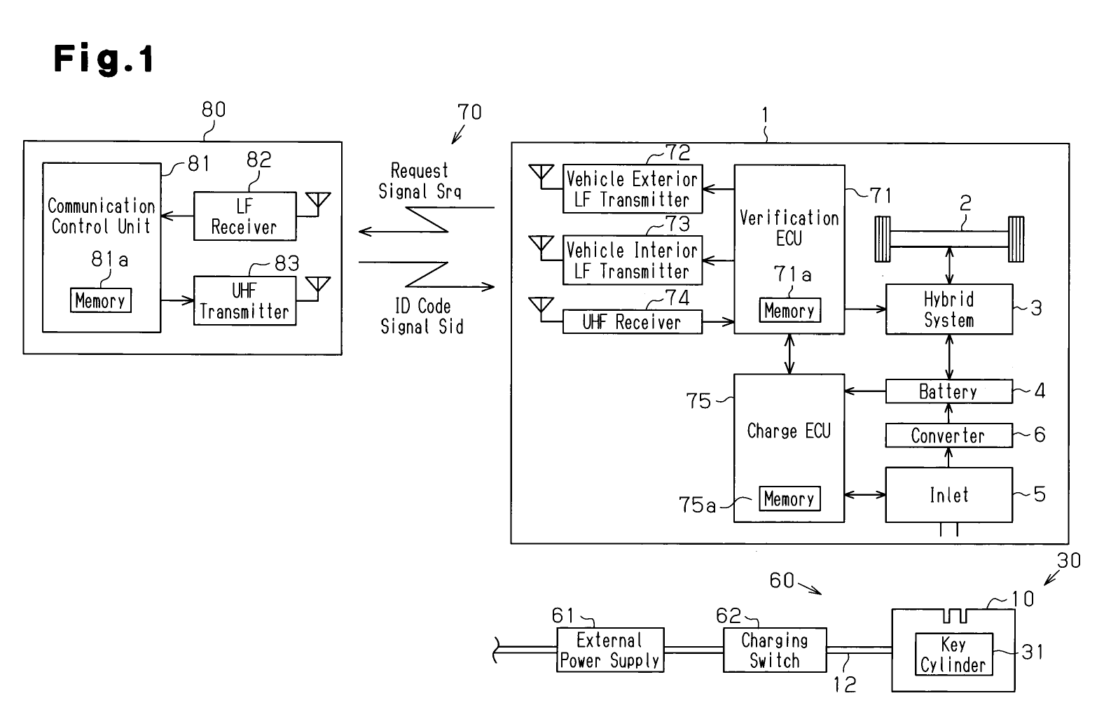

A locking device for a power feeding plug according to one embodiment of the present invention will now be described with reference to FIGS. 1 to 7.

Referring to FIG. 1, a plug-in hybrid vehicle 1 includes drive wheels 2 and a hybrid system 3, which uses an engine and a motor independently or in combination as a drive source for driving the drive wheels 2. The hybrid system 3 operates in a mode using only the engine to drive the drive wheels 2, a mode using the motor while generating electric power with the engine to drive the drive wheels 2, a mode using both the engine and the motor to drive the drive wheels 2, and a mode using only the motor to drive the drive wheels 2.

The hybrid system 3 is connected to a battery 4, which supplies the motor with power. In addition to being charged by the power generated by the engine, the battery 4 is chargeable by an external power supply 61 connected to the vehicle 1 using, for example, nighttime power supplied from a household outlet. The vehicle 1 is capable of traveling with just the motor over a longer distance than a conventional hybrid vehicle. This reduces the frequency of engine operation.

An electronic key system 70 is installed in the vehicle 1 so that vehicle operations such as the locking and unlocking of the doors can be performed without the driver actually operating a vehicle key. The electronic key system 70 uses an electronic key 80 as a vehicle key. The electronic key 80 is capable of transmitting a unique ID code through wireless communication. In the electronic key system 70, the vehicle 1 transmits an ID code response request signal Srq. In response to the request signal Srq, the electronic key 80 sends back an ID code signal Sid, which includes its ID code, to the vehicle 1 through narrowband wireless communication. When the ID code of the electronic key 80 conforms to an ID code of the vehicle 1, the electronic key system 70 permits or performs the locking and unlocking of the doors. The electronic key system 70 is one example of a wireless verification system. The electronic key 80 is one example of a communication terminal. The vehicle 1 is one example of a master device.

The electronic key system 70 will now be described. The vehicle 1 includes a verification electronic control unit (ECU) 71, which verifies the ID code in the ID code signal Sid returned from the electronic key 80 through narrowband wireless communication. The verification ECU 71 is connected to a vehicle exterior low frequency (LF) transmitter 72, a vehicle interior LF transmitter 73, and an ultrahigh frequency (UHF) receiver 74. The LF transmitter 72 is arranged in each door of the vehicle 1 and transmits wireless signals outside the vehicle in the LF band. The LF transmitter 73 is arranged in the vehicle under the floor or the like and transmits wireless signals inside the vehicle 1 in the LF band. The UHF receiver 74 is arranged in the rear of the vehicle body or the like to receive wireless signals in the UHF band. The verification ECU 71 includes a memory 71a, which stores an ID code as a unique key code.

The electronic key 80 includes a communication control unit 81, which functions to perform wireless communication with the vehicle 1 in compliance with the electronic key system 70. The communication control unit 81 includes a memory 81a, which stores an ID code as a unique key code. The communication control unit 81 is connected to an LF receiver 82, which receives signals in the LF band, and a UHF transmitter 83, which transmits signals in the UHF band in accordance with commands from the communication control unit 81.

The verification ECU 71 intermittently transmits a request signal Srq in the LF band from the vehicle exterior LF transmitter 72 at a controlled timing and forms a vehicle exterior communication area near the vehicle 1. When the electronic key 80 enters the vehicle exterior communication area and receives the request signal Srq with the LF receiver 82, the electronic key 80 sends back an ID code signal Sid including the ID code of the electronic key 80 in the UHF band from the UHF transmitter 83 in response to the request signal Srq. When receiving the ID code signal Sid with the UHF receiver 74, the verification ECU 71 compares the ID code registered in its memory 71a with the ID code of the electronic key 80 to perform ID verification (vehicle exterior verification). When vehicle exterior verification is successful, the verification ECU 71 permits or performs locking and unlocking of the doors with a door lock (not shown).

When recognizing that the doors have been unlocked upon successful vehicle exterior verification and that the driver has opened a door and entered the vehicle 1, the verification ECU 71 transmits a request signal Srq from the vehicle interior LF transmitter 73 to form a vehicle interior communication area throughout the vehicle interior. The electronic key 80 enters the vehicle interior communication area and returns an ID code signal Sid in response to the request signal Srq. When the UHF receiver 74 receives the ID code signal Sid, the verification ECU 71 verifies the ID code of the electronic key 80 with the ID code of the verification ECU 71 registered in the memory 71a to perform ID verification (vehicle interior verification). When vehicle interior verification is successful, the verification ECU 71 permits the starting of the hybrid system 3.

A plug-in vehicle battery charging system 60 will now be discussed. The charging system 60 includes a power feeding plug 10, which may be connected to an external power supply 61 arranged in, for example, a household or a charging station. The external power supply 61 may be, for example, a commercial power grid that supplies 200 V of AC power. In the illustrated example, the power feeding plug 10 is connected via a connection cable 12 to the external power supply 61. The connection cable 12 includes a charging switch 62 operated to start charging.

To charge the battery 4 of the plug-in hybrid vehicle 1, the power feeding plug 10 is connected to an inlet 5 of the vehicle 1. The inlet is also referred to as a power receiving connector. The inlet 5, which receives the power feeding plug 10, is installed, for example, in the front side wall of the vehicle body in the same manner as a fuel tank opening of a gasoline vehicle. The inlet 5 uses a converter 6 to convert the AC power from the power feeding plug 10 to DC voltage and charges the battery 4 of the vehicle 1 with the DC voltage. When the power feeding plug 10 is inserted into the inlet 5 and the ID code of the electronic key 80 carried by the user is successfully verified, the inlet 5 is permitted to charge the battery 4. The vehicle exterior communication area is formed around the entire vehicle 1. Further, the vehicle 1 generates a key inquiry (transmits a request signal Srq) so as to constantly perform polling. Thus, ID verification is performed as long as the user is carrying the electronic key 80 in front of the inlet 5. The user does not have to manually operate the electronic key 80.

The vehicle 1 includes a charge ECU 75, which executes charging-related control. The charge ECU 75 is communicable with the verification ECU 71 through an in-vehicle local area network (LAN) and is capable of checking the verification ECU 71 for ID verification results. The charge ECU 75, which is connected to the inlet 5, detects connection of the power feeding plug 10 to the inlet 5. When the power feeding plug 10 is connected to the inlet 5 and ID verification of the electronic key 80 is successful, the charge ECU 75 permits charging.

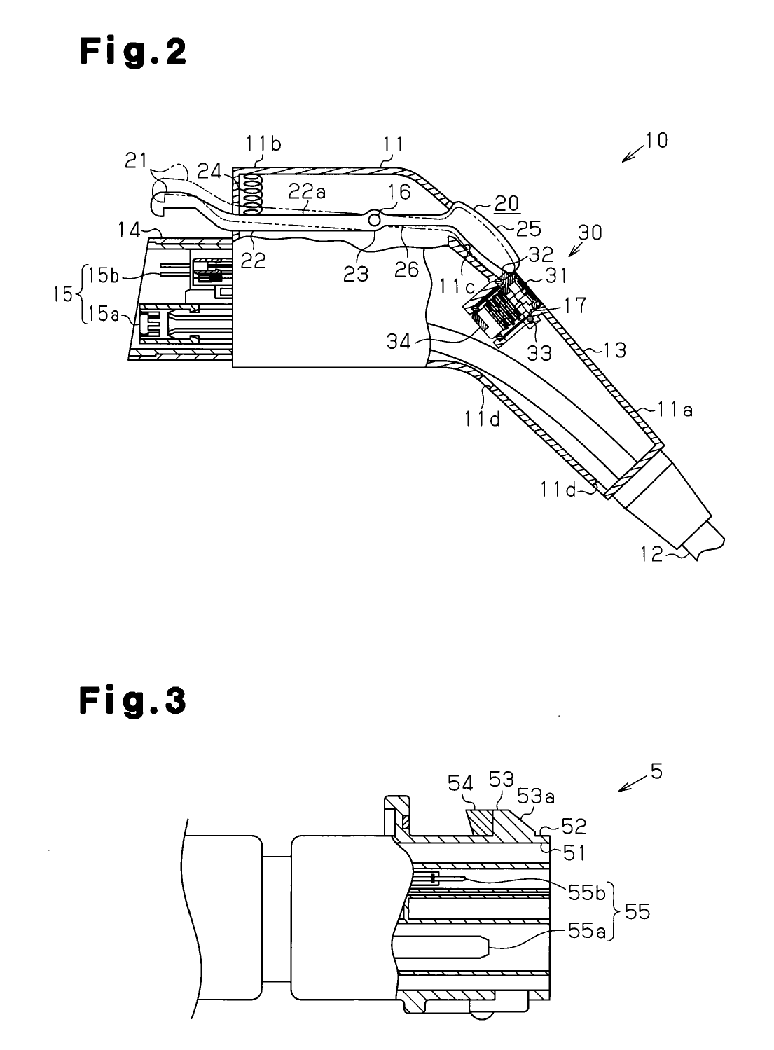

The structure of the power feeding plug 10 will now be described with reference to FIG. 2. The power feeding plug 10 has a main body 11, which includes a basal end 11a, a distal end 11b, and a grip 13. The basal end 11a is connected to the connection cable 12, which includes the charging switch 62. The distal end 11b includes a coupler 14, which is connected to the inlet 5. In the illustrated example, the coupler 14 is cylindrical. A plurality of connection terminals 15 are arranged in the coupler 14. The connection terminals 15 include a power terminal 15a, which transmits power, and control terminals 15b, which transmit various types of control commands.

The power feeding plug 10 includes a lock lever 20, When the power feeding plug 10 is inserted into the inlet 5, the lock lever 20 holds the power feeding plug 10 in the inserted state. The lock lever 20 is pivotal about a pivot shaft 16. The lock lever 20 includes a distal end defining a hook 21 and a basal end defining a manual operation portion 25. Further, the lock lever 20 includes a pivot portion 23, which is supported by the pivot shaft 16, a distal arm 22, which extends between the pivot portion 23 and the hook 21, and a basal arm 26, which extends toward the basal end. In the illustrated example, the distal arm 22 extends to above the coupler 14. The hook 21 may be formed integrally with the distal arm 22. The distal arm 22 includes an upper surface 22a. An urging spring 24 is arranged on the upper surface 22a to urge the hook 21 downward, that is, toward the coupler 14. An upper inner wall of the main body 11 supports the distal arm 22 with the urging spring 24.

The basal arm 26 extends between the pivot portion 23 and the manual operation portion 25. The basal arm 26 may be formed integrally with the manual operation portion 25, which is exposed from the main body 11. When the manual operation portion 25 is pressed, the manual operation portion 25 moves until it contacts a stopper 11c. In the illustrated example, the lock lever 20 moves between a close position, as shown by solid lines in FIG. 2, and an open position, as shown by broken lines in FIG. 2. In the close position, the hook 21 is close to the coupler 14. In the open position, the hook 21 is separated from the coupler 14.

The structure of the inlet 5 will now be described with reference to FIG. 3. The inlet 5 includes a receptacle 51. Connection terminals 55 are arranged in the receptacle 51. When the inlet 5 receives the power feeding plug 10, the connection terminals 55 are electrically connected to the connection terminals 15 of the power feeding plug 10. The connection terminals 55 include a power terminal 55a, which transmits power, and control terminals 55b, which transmit various types of control commands. The inlet 5 includes an outer surface 52. A catch 53, which defines an engagement portion, is formed on the outer surface 52. The hook 21 of the power feeding plug 10 engages the catch 53. This holds the power feeding plug 10 in the inlet 5. The catch 53 includes an engagement projection 54, which engages with the hook 21.

The hook 21 is in the close position, as shown by the solid lines in FIG. 2, when engaged with the inlet 5. When the hook 21 is in the open position, as shown by the broken lines in FIG. 2, the power feeding plug 10 is removable from the inlet 5. The hook 21 is normally urged to the close position and moved to the open position when the manual operation portion 25 is pressed.

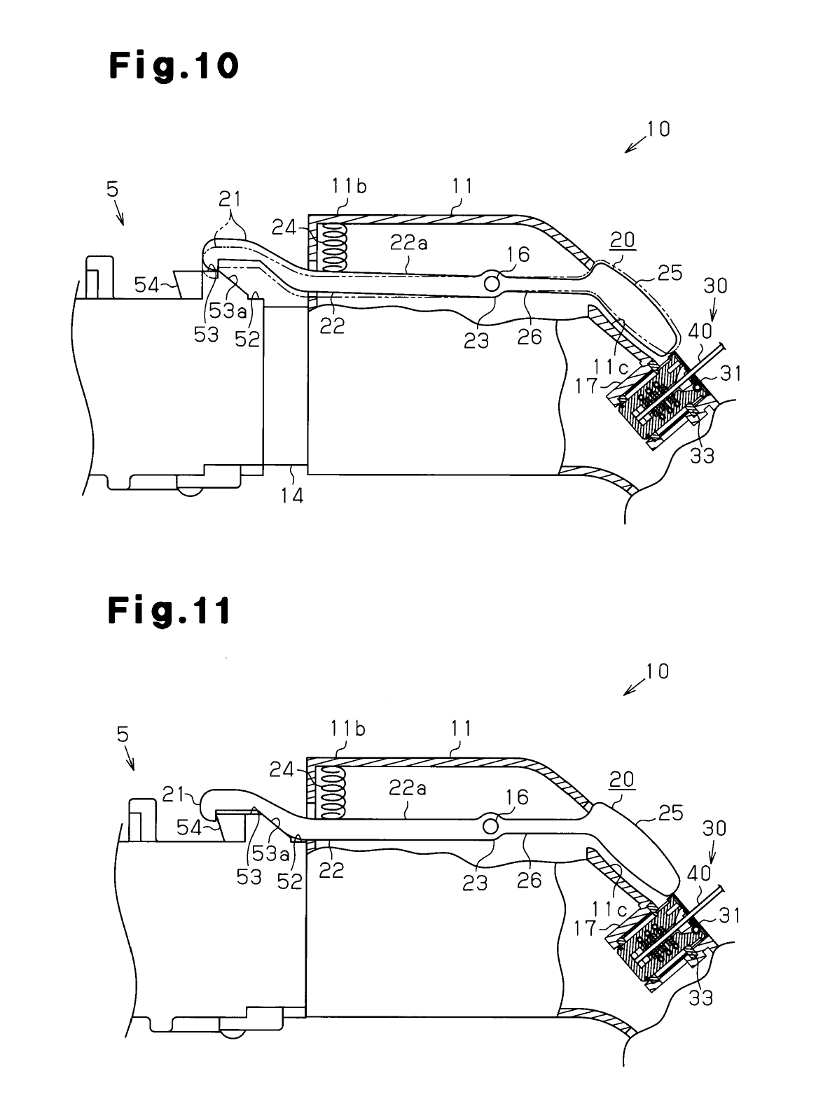

A power feeding plug locking device (hereinafter referred to as the locking device 30), which prevents unauthorized removal of the power feeding plug 10 from the inlet 5 will now be described. As shown in FIG. 2, the locking device 30 is arranged in the power feeding plug 10 and not the inlet 5 (i.e., vehicle 1). In the illustrated example, the locking device 30 includes a key cylinder 31. An authentic mechanical key 40 (refer to FIGS. 7 and 10) is inserted into the key cylinder 31 and turned between a lock position and an unlock position.

The key cylinder 31 is arranged in a retainer 17, which is formed in the main body 11 of the power feeding plug 10. The retainer 17 is made of, for example, metal and welded to the main body 11. The retainer 17 has an open upper edge, part of which is formed integrally with the stopper 11c of the main body 11. The upper open edge of the retainer 17 is inclined in conformance with the inclined outer surface of the power feeding plug 10.

As shown in FIG. 5, the key cylinder 31 includes a rotor case 33, which is fixed to the main body 11 of the power feeding plug 10, and a rotor 34, which is inserted into the rotor case 33 so as to be rotatable. The rotor case 33 has a side wall including a plurality of (in the present example, four) openings 33a, which are arranged at equal angular intervals.

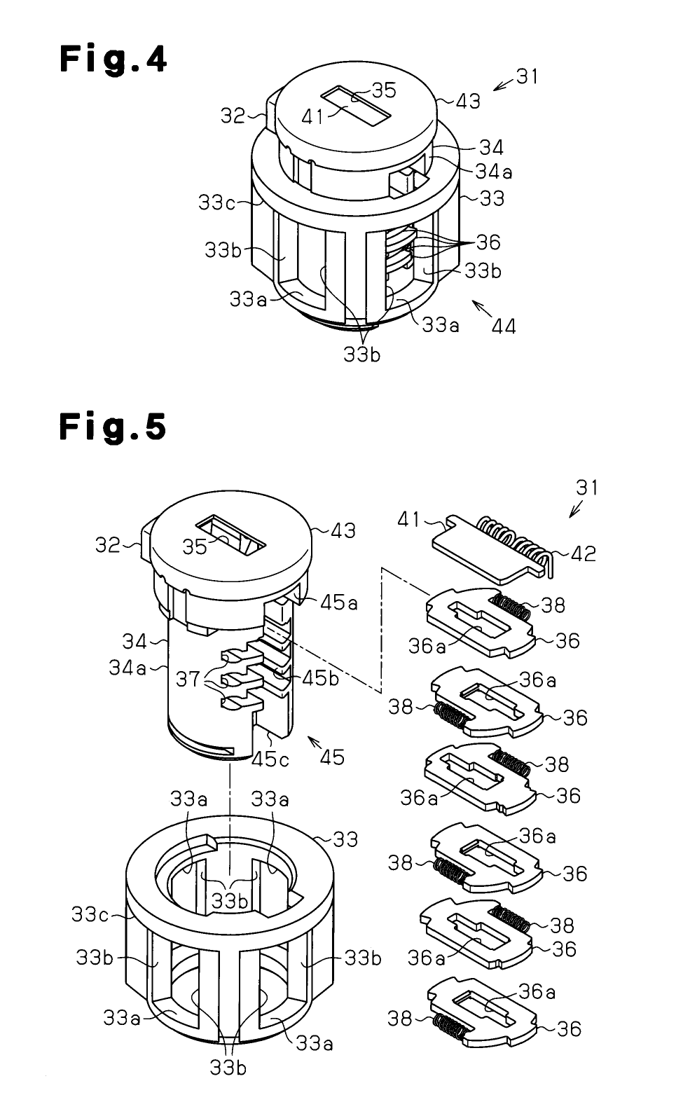

As shown in FIGS. 4 and 5, the rotor 34 includes an insertion hole 35 into which the mechanical key 40 is inserted. The rotor 34 includes a plurality of disk tumblers 36, which engage the rotor case 33 to prohibit rotation of the rotor 34. The disk tumblers 36 are arranged in parallel to one another in the axial direction of the rotor 34. Further, the rotor 34 includes a plurality of guide grooves 37, which are spaced apart from one another in the axial direction. The disk tumblers 36 are arranged in the guide grooves 37. The guide grooves 37 guide the movement of the corresponding disk tumblers 36 in the radial direction. A spring 38 is provided for each disk tumbler 36 to urge the disk tumbler 36 outward from the rotor 34 in the radial direction. This projects part of the disk tumbler 36 out of the rotor 34. In the illustrated example, each guide groove 37 accommodates two disk tumblers 36 in an overlapped state. The disk tumblers 36 are arranged in the guide grooves 37 to be alternately urged in opposite directions. Thus, the disk tumblers 36 in each guide groove 37 are urged in opposite directions.

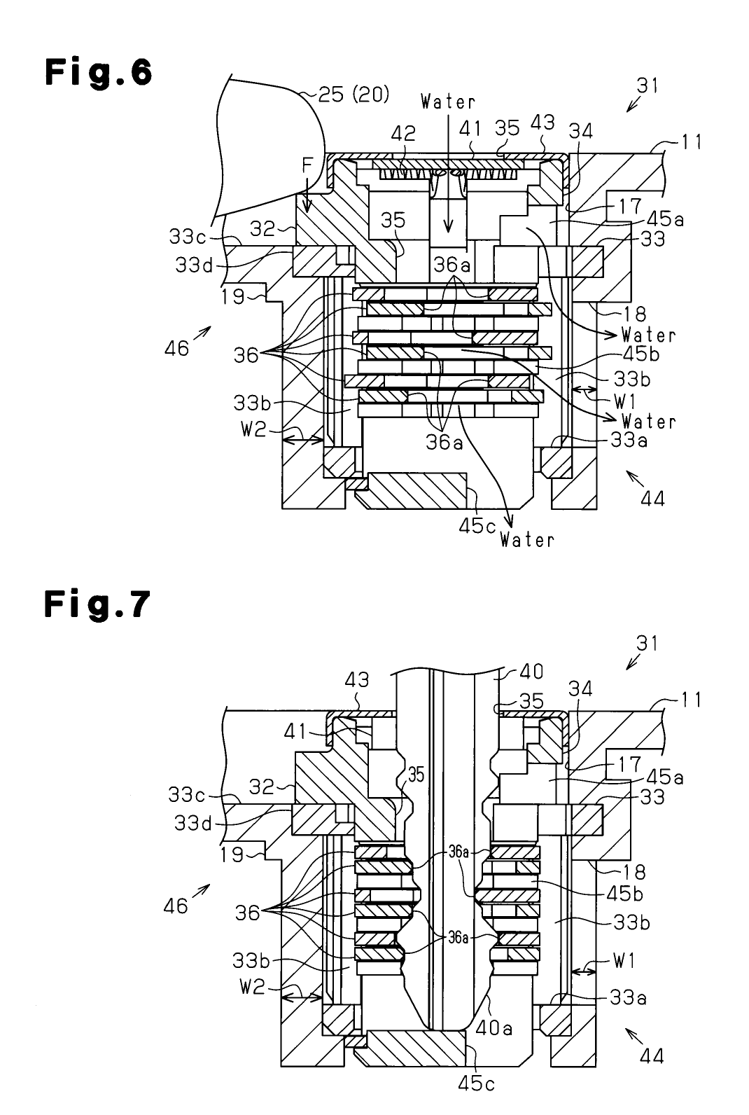

Referring to FIG. 6, when the authentic mechanical key 40 is not inserted into the insertion hole 35 of the rotor 34, each disk tumbler 36 is partially projected out of the rotor 34 by the urging force of the corresponding spring 38. The projected disk tumbler 36 contacts a side wall 33b of the corresponding opening 33a in the rotor case 33. This prohibits rotation of the rotor 34 relative to the rotor case 33. In contrast, referring to FIG. 7, when the authentic mechanical key 40 is inserted into the insertion hole 35 of the rotor 34, a key blade 40a of the mechanical key 40 contacts and moves the disk tumblers 36. This retracts the disk tumblers 36 into the rotor 34 and permits rotation of the rotor 34 relative to the rotor case 33.

As shown in FIGS. 4 to 7, a projection 32 projects integrally from a side wall of the rotor 34 in the radial direction. The locking device 30 is switched between a locked state and an unlocked state in accordance with the position of the projection 32. The rotor case 33 includes a flange 33c with an upper surface that contacts the projection 32. When the rotor 34 is rotated, the projection 32 rotates integrally with the rotor 34. The rotation of the rotor 34 moves the projection 32 to a position located below the manual operation portion 25 and to a position separated from below the manual operation portion 25. The projection 32 is also referred to as a lock mechanism and a projection member.

FIG. 9(a) shows the locking device 30 in a locked state in which the key cylinder 31 is rotated by the authentic mechanical key 40 so that the projection 32 is arranged at a lock position below the manual operation portion 25 of the lock lever 20. When operation of the lock lever 20 is attempted in this state, the manual operation portion 25 contacts the projection 32. This keeps the hook 21 at the close position (solid lines in FIG. 2). The rotation of the projection 32 removes foreign matter from the upper portion of the rotor case 33.

FIG. 9(b) shows the locking device 30 in an unlocked state in which the key cylinder 31 is rotated by the authentic mechanical key 40 so that the projection 32 is arranged at an lock position separated from below the manual operation portion 25 of the lock lever 20. In this state, when the manual operation portion 25 is pressed, the lock lever 20 pivots and moves the hook 21 to the open position (broken lines in FIG. 2). In the illustrated example, the key cylinder 31 is rotated by 90 degrees to move the projection 32 between the lock position (FIG. 9(a)) and the unlock position (FIG. 9(b)). The unlock position may differ from the illustrated position as long as the manual operation portion 25 is separated from below the manual operation portion 25.

When the projection 32 is located at the lock position, the key cylinder 31 is located at the lock position and/or the power feeding plug 10 is in a locked state. When the projection 32 is located at the unlock position, the key cylinder 31 is located at the unlock position and/or the power feeding plug 10 is in an unlocked state.

When the key cylinder 31 is located at the lock position (FIG. 9(a)), the disk tumblers 36 are arranged between a set of opposing openings 33a (refer to FIGS. 4 and 5). This allows for movement of the mechanical key 40 relative to the disk tumblers 36 in upward and downward directions as viewed in FIG. 5. Thus, when the key cylinder 31 is located at the lock position, the mechanical key 40 may be removed from the key cylinder 31. When the key cylinder 31 is located at the unlock position (FIG. 9(b)), the disk tumblers 36 are arranged between another set of opposing openings 33a. This also allows for movement of the mechanical key 40 relative to the disk tumblers 36 in upward and downward directions. Thus, when the key cylinder 31 is located at the unlock position, the mechanical key 40 may be removed from the key cylinder 31.

As shown in FIGS. 5 and 6, the key cylinder 31 includes a shell 34a, a cylinder cap 43 attached to the shell 34a, and a shutter 41. The shutter 41 is attached to the cylinder cap 43 to close the insertion hole 35. A shutter spring 42, which is formed by, for example, a torsion spring, urges the shutter 41 in the closing direction. When rain falls while charging the vehicle 1 outdoors, water may enter the rotor 34 from a gap between the shutter 41 and the cylinder cap 43.

Thus, as shown in FIGS. 4 to 8, a water drainage mechanism 44 is arranged in a lower part of the shell 34a of the rotor 34 to drain the water in the key cylinder 31 out of the locking device 30. For example, the water drainage mechanism 44 includes a drain 45 formed in the rotor 34, the openings 33a formed in the rotor case 33, and a drain 18 formed in the retainer 17. The drain 45 is cut out in a belt-like manner from the rotor 34 in the axial direction. For example, the drain 45 may include an upper drain 45a formed in an upper portion of the rotor 34, a middle drain 45b formed at a position corresponding to the disk tumblers 36, and a lower drain 45c formed at the bottom end of the rotor 34. The openings 33a of the rotor case 33 also function as drains. The drain 18 of the retainer 17 in the main body 11 of the power feeding plug 10 is formed at a position facing toward the drain 45 when the locking device 30 is arranged at the lock position. The water drainage mechanism 44 forms a fluid drainage mechanism.

As shown in FIG. 6, water that enters the rotor 34 (indicated by the arrows in FIG. 6) moves downward and is discharged from the upper drain 45a to the middle drain 45b or discharged directly outside from the lower drain 45c. Some of the water discharged from the rotor 34 passes through the openings 33a of the rotor case 33 and the drain 18 of the retainer 17 to be discharged outside. Referring to FIG. 2, the water discharged out of the retainer 17 is discharged out of the main body 11 through a plurality of main body drains 11d formed in a lower surface of the power feeding plug 10.

Referring to FIG. 6, the projection 32 includes a first side, which contacts the manual operation portion 25, and a second side, which is opposite the first side. The first and second sides of the projection 32 are also respectively referred to as upper and lower surfaces. When the locking device 30 is in the locked state, the rotor case 33 and the retainer 17 support the lower surface of the projection 32. The rotor case 33 and the retainer 17 are also referred to as a support mechanism 46. In the illustrated example, the rotor case 33 includes a rotor case support 33d, which supports the lower surface of the projection 32 from below. Further, a retainer support 19 is arranged under the rotor case support 33d. The retainer support 19 supports a lower surface of the rotor case support 33d from below. When the manual operation portion 25 comes into contact with the projection 32, load F is produced. The load F is received via the projection 32 by the rotor case support 33d and the retainer support 19. This reduces the load that is solely applied to the projection 32. The support mechanism 46 functions to prevent the projection 32 and the rotor 34 from being damaged and improves the durability of the locking device 30.

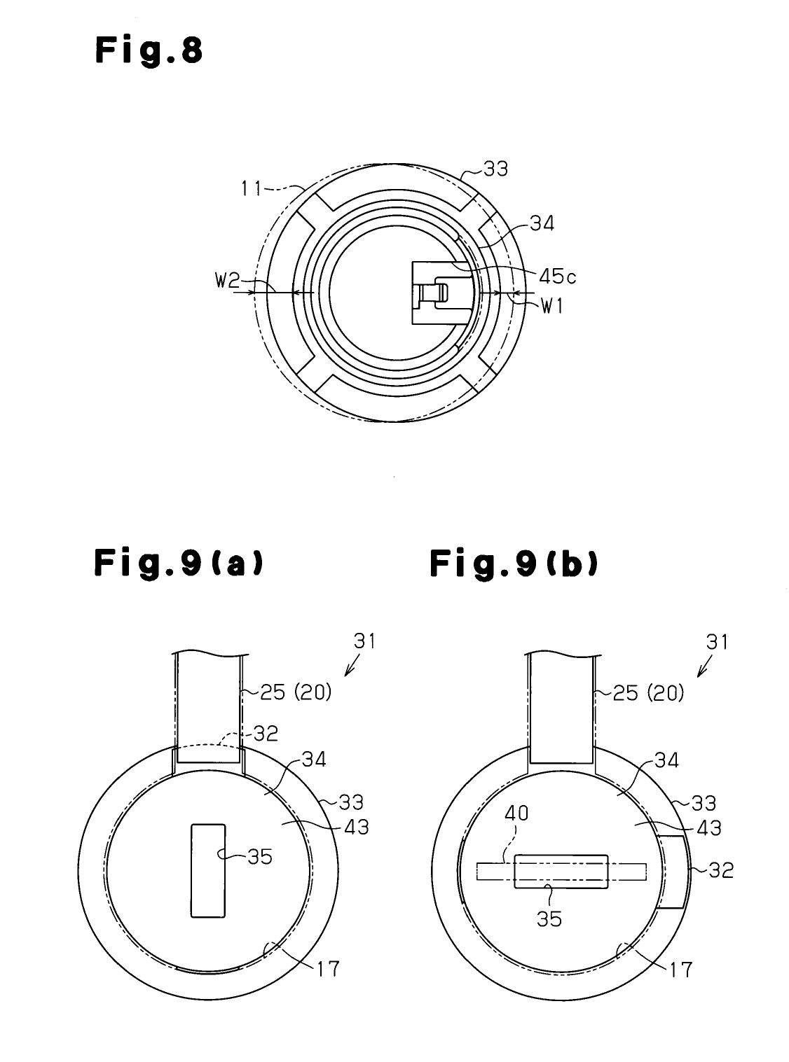

The drain 18 formed in the retainer 17 may decrease the strength of the retainer 17. To compensate for the decrease in strength, the retainer 17 has a thickness W1 at the side in which the drain 18 is formed and a thickness W2 at the side opposite to the drain 18 (refer to FIG. 8). The thickness W2 is greater than the thickness W1. This ensures that the retainer 17 has sufficient strength to avoid being damaged even when the vehicle 1 accidentally runs over the power feeding plug 10, for example.

The operation of the locking device 30 when charging the battery 4 with the power feeding plug 10 will now be described.

FIG. 10 shows the locking device 30 in an unlocked state, which is set by turning the key cylinder 31 with the mechanical key 40. In this state, the power feeding plug 10 is inserted into the inlet 5.

During insertion of the power feeding plug 10, the hook 21 comes into contact with an inclined surface 53a of the catch 53. Further insertion of the power feeding plug 10 pivots the lock lever 20 about the pivot shaft 16. The force produced when inserting the power feeding plug 10 moves the hook 21 upward along the inclined surface 53a of the catch 53. Thus, the user can insert the power feeding plug 10 into the inlet 5 without having to operate the manual operation portion 25 to move the hook 21 to the open position. The user may, however, operate the manual operation portion 25 when inserting the power feeding plug 10 into the inlet 5.

When the power feeding plug 10 is completely inserted into the inlet 5, the connection terminals 15 of the power feeding plug 10 are electrically connected to the connection terminals 55 of the inlet 5. During insertion of the power feeding plug 10, the hook 21 moves along the catch 53 in a state pressed against the upper surface of the catch 53 by the urging force of the urging spring 24. When the hook 21 reaches the engagement projection 54, the urging force of the urging spring 24 moves the hook 21 downward. This engages the hook 21 with the engagement projection 54 (FIG. 11). In this state, the manual operation portion 25 must be pressed to disengage the hook 21 from the engagement projection 54 and remove the inlet 5 from the power feeding plug 10.

When the connection terminals 15 of the power feeding plug 10 is connected to the connection terminals 55 of the inlet 5, the charge ECU 75 receives connection signals through the control terminals 55b and acknowledges connection of the power feeding plug 10 to the inlet 5. In one example, the charge ECU 75 may perform ID verification on the power feeding plug 10. When the charging switch 62 is switched on, the power feeding plug 10 starts to charge the battery 4.

In a state in which the power feeding plug 10 is inserted into the inlet 5, the user rotates the key cylinder 31 from the unlock position to the lock position with the authentic mechanical key 40. This moves the projection 32 to a position below the manual operation portion 25. In this state, the pressing of the manual operation portion 25 is restricted. That is, when the manual operation portion 25 is pressed, the manual operation portion 25 comes into contact with the projection 32. Thus, the manual operation portion 25 is locked, and the user may remove the authentic mechanical key 40 from the key cylinder 31 and leave the vehicle 1.

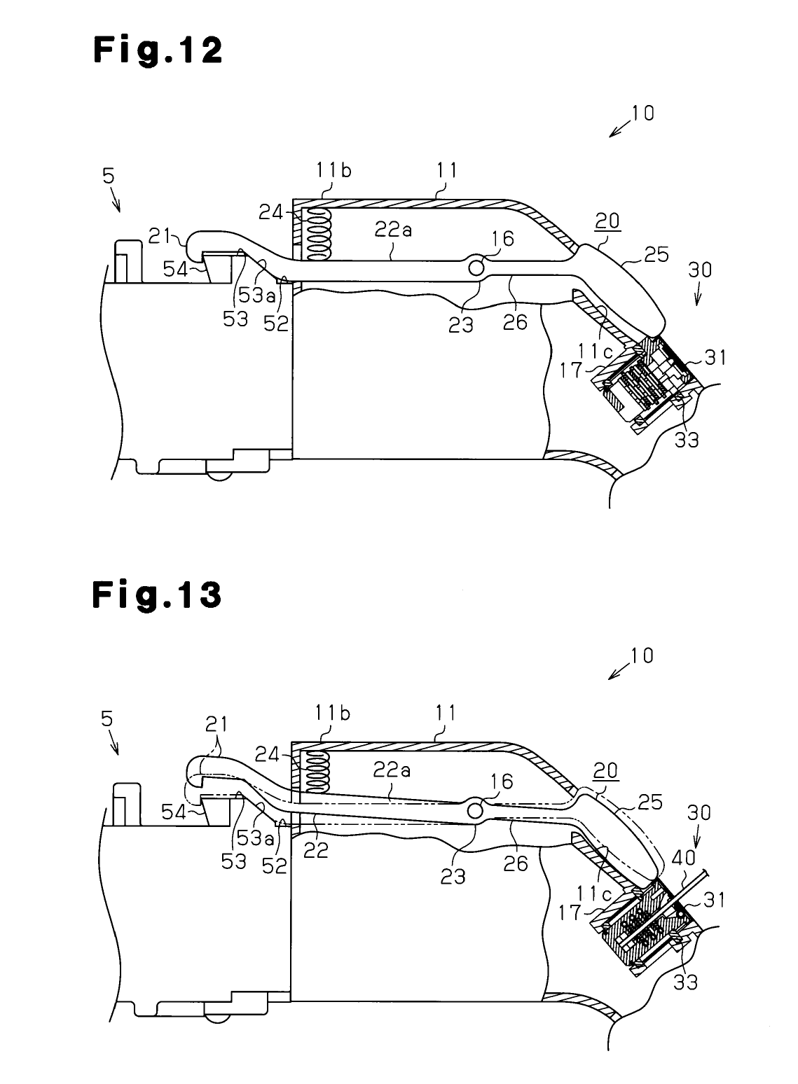

As shown in FIG. 12, when the power feeding plug 10 is in the locked state, someone may press the manual operation portion 25 to attempt to remove the power feeding plug 10 from the inlet 5. In such a case, the manual operation portion 25 comes into contact with the projection 32 and cannot be moved. Thus, the hook 21 cannot be moved to the open position. Since the hook 21 remains engaged with the catch 53, the power feeding plug 10 cannot be removed from the inlet 5. This prevents unauthorized removal of the power feeding plug 10.

When the charging of the battery 4 is completed, the user removes the power feeding plug 10 from the inlet 5. In this state, the user rotates the key cylinder 31 of the power feeding plug 10 from the lock position to the unlock position with the authentic mechanical key 40. This moves the projection 32 away from below the manual operation portion 25 to the unlock position (FIG. 13) and allows for unrestricted pressing of the manual operation portion 25. Thus, the user may press the manual operation portion 25 to move the hook 21 to the open position and remove the power feeding plug 10 from the inlet 5. Here, the two sets of the openings 33a allow the mechanical key 40 to be removed from the key cylinder 31 at the unlock position.

In the present embodiment, the key cylinder 31 is arranged in the power feeding plug 10. The projection 32, which is formed on the rotor 34 of the key cylinder 31, restricts operation of the lock lever 20. The true user would be able to unlock the key cylinder 31, operate the manual operation portion 25, and remove the power feeding plug 10. However, another person would not be able to unlock the key cylinder 31, operate the manual operation portion 25, and remove the power feeding plug 10. Thus, the power feeding plug 10 cannot be removed from the power feeding plug 10 in an unauthorized manner. This prevents electricity from being stolen and the power feeding plug 10 from being stolen.

In the illustrated example, the locking device 30 is a non-electrical device including the key cylinder 31. Thus, the locking device 30 has a simple structure, and the locking device 30 is easily manufactured. Further, the locking device 30 may be mechanically locked and unlocked just by rotating the key cylinder 31 with the mechanical key 40. Since the locking device 30 does not require electric wires or circuits, less power is consumed by the locking device 30 and the power feeding plug 10.

The present embodiment has the advantages described below.

(1) The locking device 30 of the power feeding plug 10 prevents an unauthorized person from removing the power feeding plug 10 from the inlet 5. The locking device 30 is a non-electrical device including the key cylinder 31. Thus, the locking device 30 does not require electric wires or circuits and has a simple structure.

(2) The projection 32 of the rotor 34 in the key cylinder 31 permits and prohibits operation of the manual operation portion 25 depending on where the projection 32 is located. Thus, unauthorized removal of the power feeding plug 10 is prevented with a simple structure.

(3) The locking device 30 includes the support mechanism 46, which supports the lower surface of the projection 32 from below when the projection 32 is arranged at the lock position. When the manual operation portion 25 comes into contact with the projection 32, the support mechanism 46 reduces the load that is solely applied to the projection 32. This prevents the projection 32 from being damaged and prevents unauthorized removal of the power feeding plug 10.

(4) The locking device 30 includes the water drainage mechanism 44. Thus, the water than enters the rotor 34 is discharged out of the retainer 17 through the drain 45 formed in the rotor 34, the openings 33a formed in the rotor case 33, and the drain 18 formed in the retainer 17. This prevents the key cylinder 31 from being deteriorated by water and thus prevents unauthorized removal of the power feeding plug 10 over a long period.

(5) The thickness W2 of the retainer 17 at the side opposite to the drain 18 is greater than the thickness W1 at the side in which the drain 18 is formed. This ensures that the retainer 17 has sufficient strength to avoid being damaged. Thus, the locking device 30 resists breakage even when accidentally run over by the vehicle 1. Since the locking device 30 is rigid, unauthorized removal of the power feeding plug 10 is prevented.

(6) The projection 32 contacts one end of the lock lever 20, specifically, the part of the manual operation portion 25 that is farthest from the pivot shaft 16. This decreases the mechanical strength required for the projection 32.

It should be apparent to those skilled in the art that the present invention may be embodied in many other specific forms without departing from the spirit or scope of the invention. Particularly, it should be understood that the present invention may be embodied in the following forms.

In the embodiment described above, the thickness W2 of the retainer 17 at the side opposite to the drain 18 is greater than the thickness W1 at the side in which the drain 18 is formed. However, as long as sufficient strength can be ensured for the retainer 17 even when the drain 18 is formed, the side opposite to the drain 18 does not have to be thick.

In the embodiment described above, the drain 18 is formed in the side wall of the retainer 17. However, as long as water can be drained from the lower part of the retainer 17, the drain 18 may be removed from the side wall of the retainer 17.

In the embodiment described above, the load applied to the projection 32 when operating the manual operation portion 25 is received by an overlapping structure (support mechanism 46) of the rotor case support 33d and the retainer support 19. However, when sufficient supporting strength can be obtained with just one of the rotor case support 33d and the retainer support 19, the support mechanism 46 does not have to include one of the rotor case support 33d and the retainer support 19.

In the embodiment described above, the projection 32 restricts operation of the manual operation portion 25. However, movement of the hook 21 may be restricted.

In the embodiment described above, the projection 32 is rotated integrally with the rotor 34 to restrict operation of the manual operation portion 25. However, the rotation of the rotor 34 may be converted to linear movement of a restriction member that restricts operation of the manual operation portion 25.

The lock lever 20 does not have to be arranged on the upper surface of the power feeding plug 10. For example, the lock lever 20 may be arranged on the lower surface of the power feeding plug 10.

In the embodiment described above, the manual operation portion 25 and the hook 21 do not have to be formed integrally with the lock lever 20. For example, the manual operation portion 25 may be discrete from the hook 21. In such a case, when a sensor or the like detects operation of the manual operation portion 25, an actuator may move the hook 21 to prevent removal of the power feeding plug 10. Further, the projection 32 of the key cylinder 31 may prohibit movement of the manual operation portion 25 or the hook 21 to lock the locking device 30.

In the embodiment described above, the locking device 30 does not have to restrict downward movement of the manual operation portion 25 and may restrict, for example, upward movement of the hook 21.

In the embodiment described above, the key cylinder 31 does not have to be arranged in the upper surface of the power feeding plug 10 and may be arranged in other parts of the power feeding plug 10. For example, the key cylinder 31 may be arranged in the side surface or lower surface of the power feeding plug 10.

In the embodiment described above, the user of the power feeding plug 10 is verified as being authorized based on the verification result of ID verification performed by the electronic key system 70 between the vehicle 1 and the electronic key 80. Instead, the power feeding plug 10 may include a communication device that is capable of performing wireless communication with the electronic key 80. In this case, ID verification may be performed directly between the power feeding plug 10 and the electronic key 80 to verify that the user is authorized. The communication device may be similar to that used in the vehicle 1 and include an antenna and a receiver-transmitter. When communicating with an electronic key that includes a transponder, the communication device may be a so-called immobilizer amplifier.

In the embodiment described above, ID verification is performed through wireless communication when starting charging. However, the wireless communication ID verification may be eliminated. In this case, the use of the authentic mechanical key 40 would indicate that the user is authorized.

In the embodiment described above, the hook 21 is arranged above the coupler 14 of the power feeding plug 10. However, hooks may be arranged above and below the coupler 14 so as to sandwich the coupler 14.

In the embodiment described above, the electronic key system 70 may be, for example, an immobilizer system that uses a transponder, which transmits an ID code.

In the embodiment described above, the frequencies of the radio waves used by the electronic key system 70 are not necessarily limited to LF and UHF. Radio waves of other frequencies may be used. Further, the frequency of the radio wave transmitted from the vehicle 1 to the electronic key 80 does not have to be different from the frequency of the radio wave transmitted from the electronic key 80 to the vehicle 1 and may be the same.

In the embodiment described above, the user verification is not necessarily limited to key verification that uses the electronic key 80. For example, the user verification may be another type of verification such as biometric verification.

In the embodiment described above, the present invention is applied to the inlet 5 of the plug-in hybrid vehicle 1. However, the present invention is not limited to plug-in hybrid vehicles and may be applied to an inlet of an electric vehicle.

In the embodiment described above, the locking device 30 is not limited to application to the vehicle 1 and may be used for any device or equipment that uses a chargeable battery.

The present examples and embodiments are to be considered as illustrative and not restrictive, and the invention is not to be limited to the details given herein, but may be modified within the scope and equivalence of the appended claims.

1. A locking device for a power feeding plug including a hook, which engages a power receiving connector, and a manual operation portion, which is operated to disengage the hook from the power receiving connector, the locking device comprising:
a key cylinder arranged in the power feeding plug; and
a lock mechanism moved in cooperation with the key cylinder, wherein when an authentic mechanical key operates the key cylinder, the lock mechanism is moved between a lock position, to prohibit removal of the power feeding plug from the power receiving connector, and an unlock position, to permit removal of the power feeding plug from the power receiving connector.

2. The locking device according to claim 1, wherein
the lock mechanism includes a projection member rotated integrally with a rotor of the key cylinder, and
the rotation of the rotor moves the projection member into a movement path of the hook or the manual operation portion to prohibit removal of the power feeding plug from the power receiving connector.

3. The locking device according to claim 2, further comprising:
a rotor case that holds the rotor; and
a retainer that accommodates the key cylinder, wherein
the projection member includes a first side, which contacts the hook or the manual operation portion, and a second side, which is opposite the first side, and
the rotor case cooperates with the retainer to support the second side of the projection member.

4. The locking device according to claim 1, further comprising a fluid drainage mechanism that drains fluid out of the key cylinder.

5. The locking device according to claim 4, further comprising a retainer that accommodates the key cylinder, wherein
the fluid drainage mechanism is formed in at least the retainer, and
the retainer includes a relatively thick part in which the fluid drainage mechanism is not formed and a relatively thin part in which the fluid drainage mechanism is formed.

6. The locking device according to claim 1, wherein
the hook and the manual operation portion are respectively formed on ends of a lock lever, which is pivotally supported by a pivot shaft;
the lock mechanism includes a projection member that pivots integrally with a rotor of the key cylinder; and
the projection member contacts a part of the operation member that is farthest from the pivot shaft.

7. The locking device according to claim 6, wherein
the lock lever pivots when the manual operation portion is moved downward;
the projection member prohibits downward movement of the manual operation portion when the projection member is in contact with the manual operation portion; and
the projection member permits downward movement of the manual operation portion when the projection member is out of contact with the manual operation portion.

8. The locking device according to claim 6, wherein the key cylinder is arranged adjacent to the manual operation portion.

9. The locking device according to claim 1, wherein the locking device is a mechanical device that does not require an electric wire.

10. A power feeding plug for use with a power receiving connector, the power feeding plug comprising:
a hook that engages the power receiving connector;
a manual operation portion operated to disengage the hook from the power receiving connector; and
a locking device that selectively prohibits operation of the manual operation portion, wherein the locking device includes:
a key cylinder operated by an authentic mechanical key; and
a lock mechanism that moves in cooperation with the key cylinder, wherein when the authentic mechanical key operates the key cylinder, the lock mechanism is moved between a lock position, to prohibit removal of the power feeding plug from the power receiving connector, and an unlock position, to permit removal of the power feeding plug from the power receiving connector.

11. The power feeding plug according to claim 10, wherein
the hook and the manual operation portion are respectively formed on ends of a lock lever, which is pivotally supported by a pivot shaft;
the lock mechanism includes a projection member that pivots integrally with the rotor of the key cylinder; and
the projection member contacts a part of the operation member that is farthest from the pivot shaft.

12. The power feeding plug according to claim 11, wherein
the lock lever pivots when the manual operation portion is moved downward;
the projection member prohibits downward movement of the manual operation portion when the projection member is in contact with the manual operation portion; and
the projection member permits downward movement of the manual operation portion when the projection member is out of contact with the manual operation portion.

13. The power feeding plug according to claim 10, wherein the key cylinder is arranged adjacent to the manual operation portion.
